(19) United States
(12) Patent Application Publication
(10) Pub. No.: US 2005/0022399 A1
(43) Pub. Date: Feb. 3, 2005

(54) Laser level

(76) Inventors: Thomas J. Wheeler, Pomona, CA (US); Zareh Khachatoorian, Northridge, CA (US)

Correspondence Address: MOSER, PATTERSON & SHERIDAN, L.L.P., Suite 1500, 3040 Post Oak Blvd., Houston, TX, 77056, US

(21) Appl. No.: 10/670,112

(22) Filed: Sep. 24, 2003

Related U.S. Application Data
(60) Provisional application No. 60/491,787, filed on Aug. 1, 2003.

(51) Int. Cl. G01C 15/00

(52) U.S. Cl. 33/286

(57) ABSTRACT

The present invention provides an improved laser level. In one embodiment, the laser level comprises a housing having a base. The laser level further comprises any combination of an anchor assembly, a suction assembly, or a magnet to be used for attaching the laser level to a surface. An adjustment assembly provides control and precision by allowing leveling or plumbing of the laser level after it attaches to the surface and by converting a relatively large rotation of an adjustment handle into a finer leveling adjustment of the laser level. In an embodiment, the laser level attaches to an auxiliary base that allows leveling of the laser level in two perpendicular planes and allows the laser level to attach to a tripod for use horizontally, vertically, and angles in between. In an embodiment, a rotary part allows selection from multiple lenses the one appropriate lens for the desired task.

### CROSS-REFERENCE TO RELATED APPLICATIONS

This application claims benefit of U.S. provisional patent application Ser. No. 60/491,787, filed Aug. 1, 2003, which is herein incorporated by reference.

### BACKGROUND OF THE INVENTION

b 1. Field of the Invention

The present invention relates to the field of hand tools. More particularly, embodiments of the present invention relate to a laser operated level.

2. Description of the Related Art

During construction and remodeling projects, it is often desirable to install an object along a horizontal plane or line. Examples include the laying of a walkway, the erection of a wall, the installation of window frames, and the hanging of pictures on a wall. To accomplish a level or perpendicular installation, various tools have been used such as rulers, T-squares, and plumb bobs. It has also been known to employ an elongated bar that incorporates a liquid-holding vial, or “bubble vial.” The vial includes integral marks for aligning a “bubble” of liquid there between. Such tools are known as levels.

Recently, levels have been developed that incorporate laser technology. Such laser levels are sometimes referred to as laser alignment devices. Laser alignment devices utilize a laser beam generator for projecting a light beam onto a surface. The laser beam generator or laser is an active electron device that converts an input power into a very narrow, intense beam or “dot” of coherent visible light. The input power excites the atoms of an optical resonator to a higher energy level, and the resonator forces the excited atoms to resonate in phase. The surface that the light beam projects onto is remote from a reference surface on which the level is placed. From there, the beam relates the orientation or position of the reference surface with the remote surface.

There are a variety of tools on the market that utilize lasers to aid in construction and home improvement projects. Typically, such laser levels first comprise a housing. The housing includes a base that is constructed and arranged to be engaged with a reference surface such as a vertical wall or a work surface. As with mechanical levels, the laser levels also typically include a bubble vial, although electronic level indicators are known in precision applications. The bubble vial is carried by the housing and is constructed and arranged to indicate an orientation of the housing and, hence, an orientation of the reference surface when the base is engaged therewith. Known laser levels include a laser that also resides within the housing and emits a laser beam from the housing to a location on a surface remote from the housing. The laser beam is directed at a predetermined orientation with respect to the vials to interrelate the orientation of the housing or the base and the orientation of the reference surface. Commonly, the laser is designed to rotate at a relatively high speed. This in essence creates an apparent level line around a full 360 degrees even though the laser itself produces only a “dot.”

Another category of laser alignment devices resembles the traditional mechanical level. A laser is added that has an axis substantially parallel to the level's base and sidewall. Often the laser is coupled to a refraction device or lens that can create a vertical line, a horizontal line, or simultaneous vertical and horizontal lines in a “cross” shape from the “dot” that the laser produces. These refraction devices are necessary with these laser levels since they do not spin and therefore produce an apparent line like those devices described above. Often these devices also include tripod-mounting capability. However, they rely on the tripod's adjustment mechanisms in conjunction with their own vials to ensure that the laser line is level (or plumb, depending on the application).

Early on, laser levels were employed by those needing precision measurements. Recently, laser devices have been introduced for the “do-it-yourself” market. Such laser levels are typically used for lining up pictures, leveling shelving and molding, and for decorative jobs such as wallpaper and painting. Examples of such products currently on the market include the CRAFTSMAN® 4-in-1 LEVEL WITH LASER TRAC™, the STRAIT-LINE™ laser level, and the Black and Decker® Bull's Eye™ laser level. Each of these devices is intended to be mounted on a vertical wall in a level condition and to produce a level line on that same wall. The first two devices produce a laser light line in a single direction, while the Black and Decker® level produces a laser light line in both directions. The CRAFTSMAN® product also has the capability of being mounted on a tripod and producing vertical or horizontal lines on opposing walls.

In some instances a laser beam configuring lens assembly is provided. The laser beam configuring lens assembly is carried by the housing and can slide linearly between two positions with respect to the laser beam source. This permits the emitted laser beam to take one of two object shapes by linearly sliding between the two positions. However, providing the sliding ability requires clearance in the lens assembly that reduces accuracy of the level by an appreciable amount. Alternatively, the lens assembly can have a single lens that rotates ninety degrees to produce horizontal lines, vertical lines, and angles in between. Single lens devices refract the laser beam for specific applications such as an asymmetrical laser distribution specifically suited for use on the wall that the device is attached to or a symmetrical distribution particularly compatible for displaying a line on an opposing wall. When attempting to use a lens that provides the asymmetrical distribution to provide a line on an opposing wall, the line often fails to cover the entire wall due to the narrow dispersion of the asymmetrical distribution. The lens for symmetrical distribution can display a line on the same wall as the device; however, the line is often faint and difficult to see since not all of the energy of the laser is directed at the intended surface.

As noted, a base is commonly provided on the underside of the laser level housing. In some instances, the base is constructed and arranged to be mounted onto a tripod. Alternatively, some laser level bases employ a plurality of spikes that are used to penetrate a vertical wall. In this manner, the laser level can be affixed to the wall. Spikes used to attach the laser level to the wall can leave two or more unsightly and damaging holes in the wall after usage. The mechanisms for extending the spikes are often quite difficult to operate since they are small and become recessed within an obstruction prior to complete extension of the spikes. Additionally, inadvertent extension of the spikes can be dangerous and damaging to property. Once attached to the wall, the device often lacks a mechanism to adjust the level of the device. Even if adjustments are possible, a one to one relationship in the adjustment mechanism decreases the device's accuracy due to the lack of adjustment sensitivity.

A need exists for an improved laser level. More specifically, there is a need for a laser level that has improved wall mounting features. There is a further need for a laser level that provides a plurality of laser beam configuring lenses. Further still, there is a need for a laser level that is capable of being micro adjusted after being positioned onto a flat surface.

### SUMMARY OF THE INVENTION

Embodiments of the present invention generally relate to an improved laser level. The laser level includes any combination of an anchor assembly, a suction assembly, or a magnet to be used for attaching the laser level to a surface. An adjustment assembly provides control and precision by allowing leveling or plumbing of the laser level after it attaches to the surface and by converting a relatively large rotation of an adjustment handle into a finer leveling adjustment of the laser level. In an embodiment, the laser level attaches to an auxiliary base that allows leveling of the laser level in two perpendicular planes and allows the laser level to attach to a tripod for use horizontally, vertically, and angles in between. In an embodiment, a rotary part allows selection from multiple lenses the one appropriate lens for the desired task.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a front view of an embodiment of a laser level.

FIG. 2 is a back view of the laser level.

FIG. 3 is a top view of a locking mechanism within an anchoring assembly of the laser level shown in an unlocked position.

FIG. 4 is a top view of the locking mechanism in a locked position.

FIG. 5 is a sectional view of the laser level along a width of the laser level.

FIG. 6 is a bottom view of the laser level.

FIG. 7 is a perspective view of the laser level with a housing removed.

FIG. 8 is a front sectional view of the laser level with the housing removed.

FIG. 9 is a side view of an adjustment handle of an adjustment assembly of the laser level.

FIG. 10 is a view of a lens assembly attached to the laser level.

FIG. 11 is an isometric view of an auxiliary base for use with the laser level.

FIG. 12 is a bottom view of the auxiliary base.

FIG. 13 is a view of the laser level mounted on the auxiliary base.

FIG. 14 is a bottom view of an adapter unit attachable to the laser level to provide an adhesive attachment surface.

FIG. 15 is a top view of an adhesive base unit attachable to the laser level.

### DETAILED DESCRIPTION OF THE PREFERRED EMBODIMENT

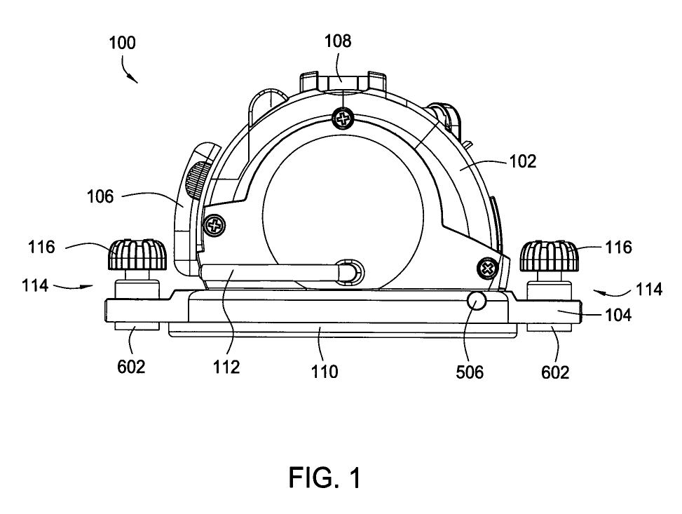

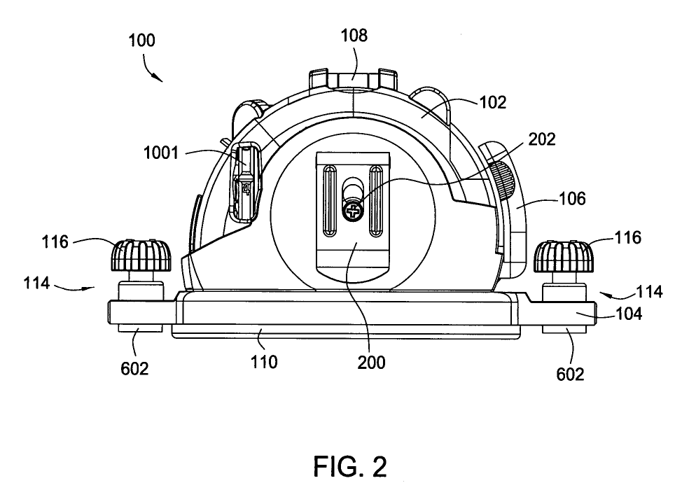

Embodiments of the present invention generally relate to an improved laser level 100. FIG. 1 presents the laser level 100 with an external housing 102 that covers some portions of the laser level located on top of a base 104. Also shown in FIG. 1 is an adjustment handle 106, a leveling vial 108, two anchoring assemblies 114 at each end of the laser level 100, and an elastomeric pad 110 proximate the base that is operated by a suction lever 112. The laser level 100 generally comprises the size and shape of a tape measure. FIG. 2 illustrates a back side of the laser level 100 with a belt clip 200 attached to the housing 102 by a screw 202. The belt clip 200 is similar to those on tape measures and provides convenient storage and transport of the laser level 100.

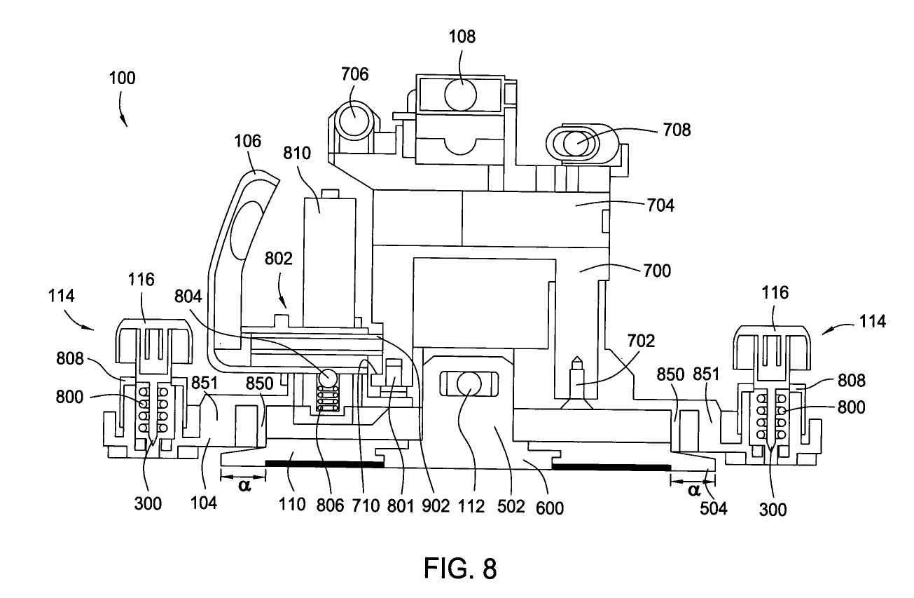

Referring to FIG. 1 and the section view shown in FIG. 8, the base 104 of the laser level 100 houses the two anchoring assemblies 114 that include retractable sharpened projections or spikes 300 that push into a vertical wall (not shown) or surface made of a material such as drywall, plaster, wood, or any other suitably soft material. As shown, each anchoring assembly 114 has only one spike 300; however, multiple spikes can be used if necessary. Two knobs 116 of the anchoring assemblies 114 are positioned, sized, and shaped such that pushing on the knobs 116 with one's palm or thumb extends the operatively connected retractable spikes 300 to an extended position. During the entire stroke between a retracted position and the extended position, the knobs 116 of the anchoring assemblies 114 remain substantially outside of the base 104 or any other obstruction. The spikes 300 are biased inward to the retracted position by a biasing member such as a spring 800 within each anchoring assembly 114 so that the spikes 300 are not exposed below a plane of the base 104 except when extended into the wall. In the extended position, friction between the spikes 300 and the wall is great enough to prevent the bias of the spring 800 from pulling the spikes 300 out of the wall. In this manner, the laser level 100 can attach to a substantially vertical wall in a manner that allows a level laser line to project onto that same wall.

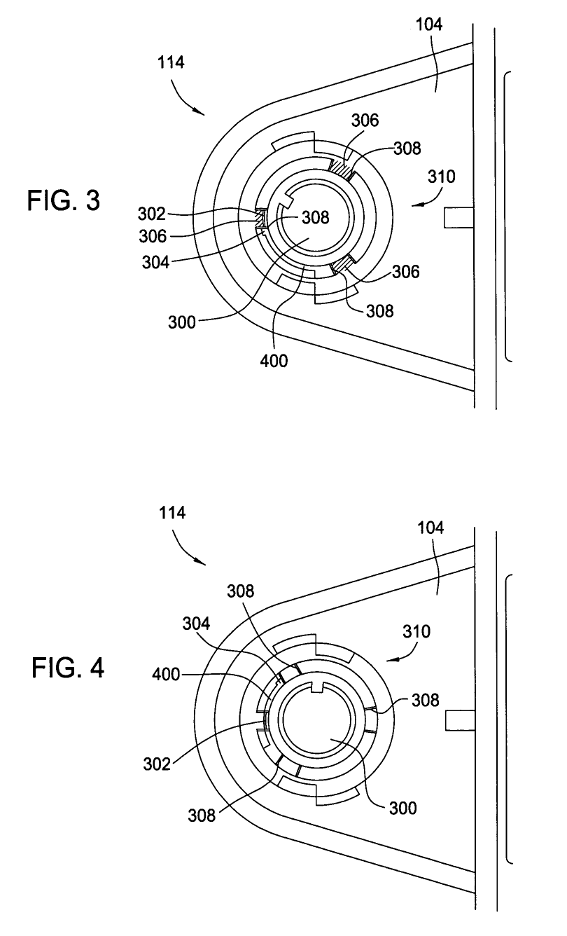

FIG. 3 and FIG. 4 illustrate a top view of a locking mechanism 310 within the anchoring assembly 114 used to secure the spike 300 in the retracted position when not in use. In order to show the locking mechanism 310 in FIG. 3 and FIG. 4, the knob 116 and a spring retention cap 808 have been removed. In an unlocked position as shown in FIG. 3, three ribs 306 of the base 104 align with three slots 308 in the spike 300 to permit the spike 300 to extend to the extended position. While three ribs 306 and three slots 308 are shown, the locking mechanism 310 can utilize any number of ribs 306 and slots 308. The ribs 306 comprise formations that protrude inward within a substantially circular aperture through the base 104. The slots 308 comprise recesses in an outside circumference of a substantially cylindrical upper portion of the spike 300 that is adapted to move axially through the aperture of the base 104. Since the slots 308 of the spike 300 substantially surround the ribs 306 of the base 104 in the extended position, the knob cannot be rotated when the anchoring assembly 114 is in the extended position. With the spike 300 in the retracted position, the ribs 306 of the base lack interference with an outside diameter of the spike 300 due to axial separation between the ribs 306 and the upper portion of the spike 300. Further, the lower portion of the spike 300 that is adjacent the ribs 306 in the retracted position lacks interference with the ribs 306 since the diameter of the lower portion of the spike 300 is sufficiently reduced such that its entire outside circumference is within the area defined by the ribs 306.

Turning the knob 116 (shown in FIG. 1) while in the retracted position rotates the spike 300 relative to the base 104 and places the locking mechanism 310 in the locked position illustrated in FIG. 4. Rotation of the spike 300 causes a mating detent 304 on the upper portion of the spike 300 to overcome a detent 302 that is rotationally fixed to the base 104 adjacent the mating detent 304 in the retracted position. The detent 302 protrudes towards the spike 300 and frictionally interferes with the outside circumference of the spike 300 that forms the mating detent 304. Once the mating detent 304 of the spike overcomes the frictional interference from the detent 302, a recessed portion 400 of the outside circumference of the spike 300 allows rotational movement of the spike 300 across the detent 302 throughout the entire recessed portion 400. Thus, the locking mechanism 310 provides substantially more circumferential play in the locked position than in the unlocked position in order to give a physical signal as to whether the anchoring assembly 114 is in the extended or retracted position. In the locked position, the three ribs 306 on the base misalign with the three corresponding slots 308 of the upper portion of the spike 300 that is positioned axially adjacent the three ribs 306. Misalignment between the ribs 306 and the slots 308 prevents the spike 300 from extending out of the base 104.

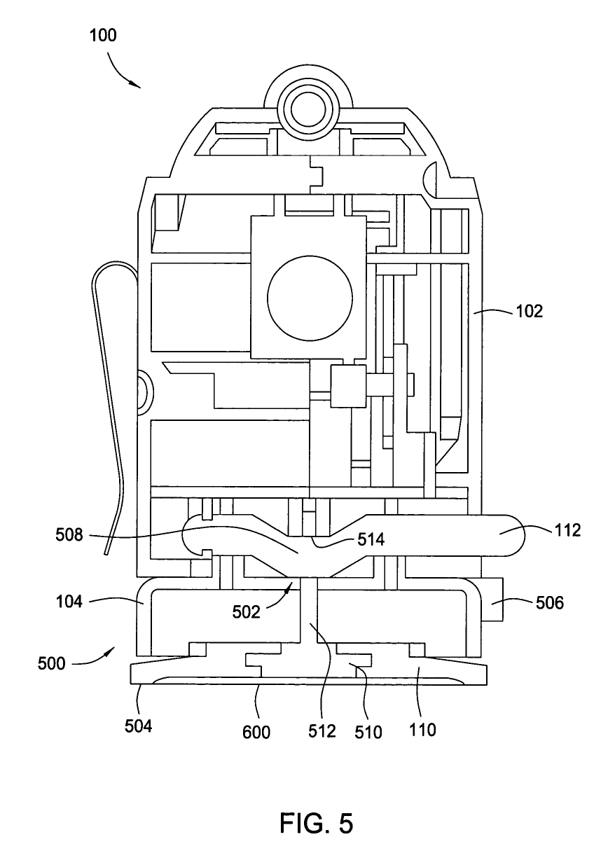

As shown in FIG. 5, a suction assembly 500 within the base 104 includes the elastomeric pad 110 having a yoke 502 molded into it and the suction lever 112 positioned through the yoke 502. The pad 110 and yoke 502 shown are made of rubber and sheet metal, respectively. An insert portion 510 of the yoke 502 secures the yoke 502 to the pad 110, and a longitudinal member 512 extends from the insert portion 510 through the base 104 of the laser level 100. The suction lever 112 fits through an aperture 514 at one end of the longitudinal member 512 of the yoke 502. The lever 112 is substantially a cylindrical form having an approximate ninety degree bend prior to entering the housing 102 and an eccentric portion 508 proximate where the lever 112 interacts with the yoke 502. Initially, the eccentric portion 508 curves downward toward the base 104. Once the lever 112 rotates, the eccentric portion 508 rotates about an axis offset from its own center such that the eccentric portion 508 curves upward from the base. This arrangement forms a Scotch Yoke mechanism that imparts linear movement to the yoke 502 from the rotational movement of the suction lever 112. Thus, the yoke 502 raises or lifts the attached pad 110 when the suction lever 112 rotates due to the interaction of the eccentric portion 508 with the aperture 514 in the yoke 502.

In operation, the concentrated load from a periphery wall of the base 104 to a raised portion or lip 504 around the periphery of the pad 110 creates an airtight seal between the laser level 100 and a relatively smooth surface so that a suction force is created when the lever 112 rotates and raises a center portion of the pad 110. The lever 112 rotates slightly more than 180 degrees so that it goes over center and has a positive stop 506 on the base 104. While flat pads work very well on flat surfaces and produce high holding power due to high decompression ratios, the lip 504 creates a better seal by concentrating the load over a smaller area. Because the load is more concentrated, the pad 110 deflects more when in use and conforms to irregular surfaces more easily. In this manner, the lip 504 maximizes the holding power of the suction assembly 500 for somewhat irregular surfaces such as drywall and plaster. Thus, the suction assembly 500 provides a second attachment option for attaching the laser level 100 to a surface.

Referring to FIG. 8, an embodiment of the base 104 includes an outer periphery wall 851 and an inner wall 850. A perimeter of the inner wall 850 is located a distance inside of the outer periphery wall 851. Therefore, both the outer periphery wall 851 and the inner wall 850 press against the pad 110 to provide an air tight seal at each location around the pad 110 once the suction assembly 500 operates. The narrowness of the outer periphery wall 851 and the inner wall 850 helps to exert locally high pressure on the pad 110 in order to conform to irregularities of an attachment surface and thereby provide a seal. In order for the suction assembly 500 to leak, air must travel a distance a from the outside of the outer periphery wall 851 to the inside of the inner wall 850 through the attachment surface. Further, a portion of the pad 110 between the outer periphery wall 851 and the inner wall 850 sucks into the attachment surface when the suction assembly 500 operates and effectively seals the distance a. Analogous to a piston using several rings to create an effective seal, the suction assembly 500 can include one or more inner walls such as the inner wall 850 in order to form the seal with attachment surfaces made from porous materials.

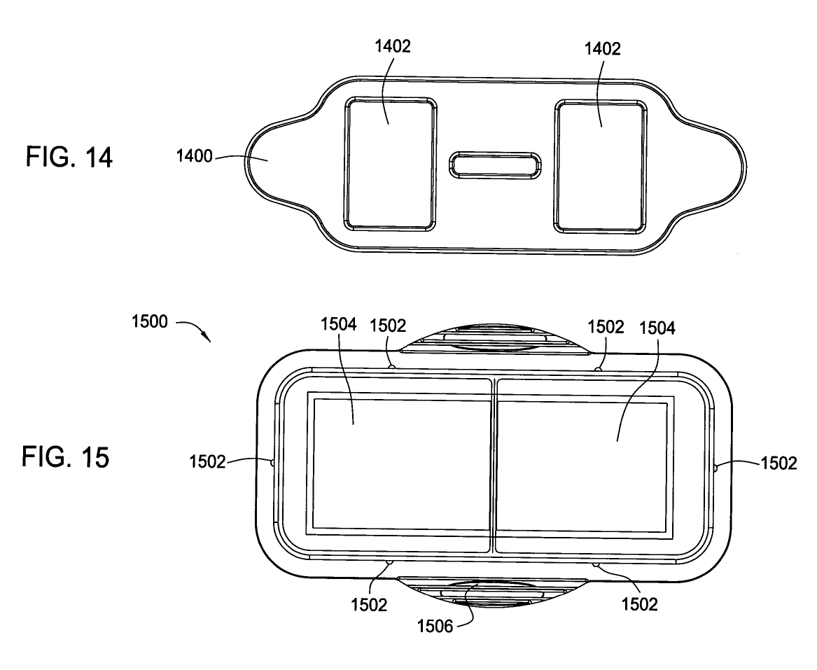

Typically, the suction assembly 500 provides sufficient anchoring of the laser level 100 to a surface. Therefore, the laser level 100 attaches to the surface without penetrating or otherwise damaging the surface. If for some reason the surface to attach the laser level 100 to is particularly rough or porous and an air tight seal can not be generated by the suction assembly 500, the anchoring assemblies 114 described above or the adapter unit 1400 described in FIG. 14 can be used as a secondary or tertiary attachment option.

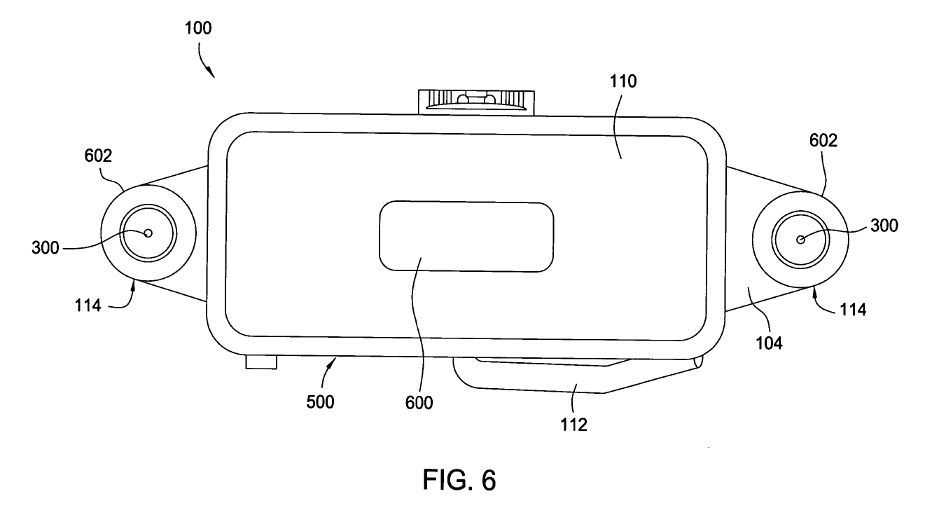

FIG. 6 shows a bottom side of the base 104 of the laser level 100 and a magnet 600 centrally located on the bottom side of the laser level. The magnet 600 provides a third attachment option for holding the laser level 100 on ferrous structures commonly used as construction material. While only one magnet 600 is centrally shown, multiple magnets may be used. The magnet 600 placed at the center of the pad 110 is either integral to the yoke 502 (shown in FIG. 5) or assembled to it by appropriate means. Additionally, the base 104 may include optional or auxiliary magnets 602 located on the bottom side of the base 104 adjacent the anchoring assemblies 114. Any magnets positioned outside of the pad 110, such as the auxiliary magnets 602, must be offset some distance from the surface of the laser level 100 that mates with the surface to attach to since the pad 110 of the suction assembly 500 compresses some when operated. Without the offset, the auxiliary magnets 602 prevent compression of the pad 110 thus preventing an airtight seal from developing. In use, the magnet 600 provides an easy to use option for attachment of the laser level 100 to a surface or different accessories such as ones designed for tripod attachment and for tool leveling.

Since magnets create significantly more holding force when actually touching a ferrous structure than when separated from that ferrous structure even by a small amount, locating the magnet 600 at the center of the pad 110 allows incorporation of the suction assembly 500 and the magnet 600 in the same laser level 100. With the magnet 600 at the center of the pad, the magnet 600 directly touches an intended mating surface. Further, the magnet 600 does not impede the compression of the pad 110 when the suction assembly 500 operates since raising of the yoke 502 described above pulls the magnet 600 out of the way. Therefore, the position and design of the magnet 600 avoids requiring large and costly magnets to generate sufficient force to adequately hold the laser level 100 since there is no need to offset the magnet 600 from the surface to contact.

The laser level 100 can include a fourth attachment option when coupled to an adapter unit 1400 shown in FIG. 14 or an adhesive base unit 1500 shown in FIG. 15. Both the adapter unit 1400 and the adhesive base unit 1500 provide a substantially flat and rigid surface on a bottom side of the laser level that an adhesive such as a releasable double sided tape or foam affixes thereto. As such, the adhesive affixes to the adapter unit 1400 or the adhesive base unit 1500 and provides an adhesive surface that contacts an attachment surface in order to attach the laser level to the attachment surface. As shown on an underside of the adapter unit 1400, the adhesive base unit 1500 and the adapter unit 1400 can include raised portions 1402 for ensuring that the adhesive adheres securely to the attachment surface, conforms well to surface irregularities, and is not restricted from being compressed during application. The adapter unit 1400 is made of a ferrous material so that the adapter unit 1400 magnetically attaches to the laser level as described above. Therefore, the adapter unit 1400 can attach to the laser level 100 having the suction assembly 500 as described above in order to provide four alternative methods of attaching the laser level to the surface. If the laser level 100 described herein lacks the suction assembly 500, the adhesive base unit 1500 can insert into a recessed portion of the base 104 of the laser level 100. Walls perpendicular to a bottom surface of the adhesive base unit 1500 insert into the base 104 and define at least one compartment 1504 for storage of the adhesive material therein. The walls of the adhesive base unit 1500 have rib formations 1502 on an outside thereof in order to provide an interference fit with the base 104 of the laser level 100. Enlarged portions extending on each side of the bottom surface of the adhesive base unit 1500 provide grip areas 1506 for removing the adhesive base unit 1500 from the laser level 100.

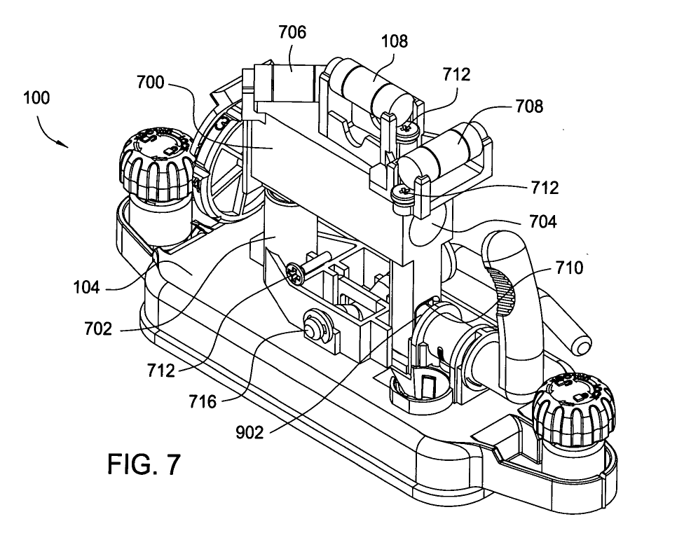

FIG. 7 illustrates the laser level 100 with the housing 102 (shown in FIG. 1 and FIG. 2) removed. The housing 102 substantially surrounds a structural member 700 with two clamshell halves rigidly affixed to the structural member 700. The structural member 700 pivotally affixes to the base 104 at a pivot point 702 and secures a laser 704 and at least one leveling vial 108. The pivot point 702 can include any known pivot attachment or arrangement. As shown, the pivot point 702 is about a screw that connects the base 104 to the structural member 700. Preferably the structural member 700 secures three leveling vials 108, 706, 708. The 45-degree vial 706 allows the laser level 100 to accurately mount on a vertical surface and project an accurate 45-degree line on that surface. Actual shape of the structural member 700 can be any shape suitable for affixing to the base 104 and securing the laser 704 and the vials 108, 706, 708. Various adjustment screws such as screws 712 allow calibration of the vials, the laser, and an optional lens assembly relative to each other. Tuning of the adjustment screws 712 insures that when the vials 108, 706, 708 read level, horizontal, or plumb that the laser 704 projects an accurate horizontal or vertical line. A power source shown as a battery 810 in FIG. 8 supplies power to the laser 704 when a switch (not shown) moves to an on position. Apertures within the housing 102 correspond to a path for the laser to project through and provide access to view the vials 108, 706, 708. In one embodiment, a window member (not shown) pivots on the structural member 700 downward and moves the switch to the on position to turn on the laser 704 that projects through the aperture of the housing 102 that is unobstructed due to displacement of the window member.

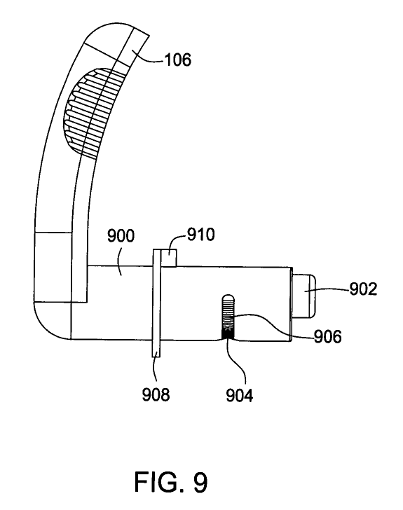

FIGS. 7 through 9 illustrate features of an adjustment assembly 802 that allows the structural member 700 to pivot several degrees in both directions relative to the base 104 by means of a second Scotch Yoke mechanism. FIGS. 9 shows the adjustment handle 106 having a cylindrical form 900 extending at an approximate ninety degree angle from its end and an eccentric end portion 902 at the opposite end of the cylindrical form 900. The eccentric end portion 902 inserts into an aperture 710 in the structural member 700 to provide a yoke as shown in FIG. 7 and FIG. 8. The eccentric end portion 902 interacts with the aperture 710 to translate rotational movement of the adjustment handle 106 into pivotal movement of the structural member 700. In order for the adjustment assembly 802 to provide movement between the base 104 and the structural member 700, the yoke end of the structural member 700 is substantially opposite the pivot point 702 where the structural member 700 pivotally affixes to the base 104. Additionally, coupling of the yoke end of the structural member to the base is provided by any known non-fixed coupling 801 such as a screw that secures into the structural member 700 and travels within a slot in the base 104. The eccentric end portion 902 rotates about a center offset from its own center when the adjustment handle 106 rotates. Therefore, the eccentric end portion 902 makes a partial orbital path that the yoke translates into linear movement to pivot the structural member 700 at the pivot point 702.

Referring to FIG. 9, the adjustment handle 106 includes a locating flange 908 and stop rib 910. The housing (not shown) traps the locating flange 908 in order to maintain the position of the adjustment handle 106 within the laser level. Additionally, a void in the housing (not shown) adjacent where the locating flange 908 is trapped permits rotational movement of the stop rib 910 only within the void. Preferably, the adjustment handle 106 rotates substantially 60 degrees in each direction from a center position. Additionally, the adjustment handle 106 includes a groove 906 and a detent 904 within an outside circumference of the adjustment handle 106. As illustrated in FIG. 8, the groove 906 provides a track that a ball bearing 804 is biased into by a biasing member such as a spring 806. The ball bearing 804 partially enters into the detent 904 in order to provide an indication of the center position based upon the increased frictional resistance provided by the ball bearing 804 when positioned within the detent 904.

After the laser level 100 attaches to a surface, rotational movement of the adjustment handle 106 of the adjustment assembly 802 allows accurate leveling of the laser level 100. The adjustment assembly 802 provides control and precision in leveling or plumbing of the laser level after it attaches to the surface since the adjustment assembly 802 converts a relatively large rotation of the adjustment handle 106 into a finer leveling adjustment of the laser level 100. Thus, the adjustment assembly 802 provides micro adjustment/leveling capabilities after the laser level 100 attaches to the surface in order to improve accuracy of the laser level. This improvement in accuracy indirectly allows the use of more sensitive vials 108, 706, 708 to further increase the accuracy of the laser level 100. Thus, the vials 108, 706, 708 are preferably “10 minute” vials or 1/6^{th} degree resolution.

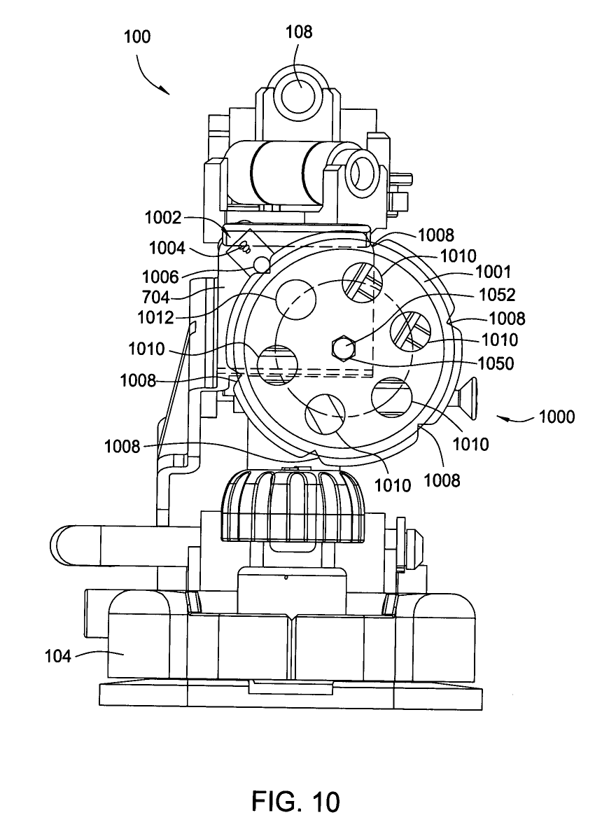

As shown in FIG. 10, the laser level 100 optionally includes a lens assembly 1000 having a plurality of different refraction devices or lenses 1010 to be utilized depending on what is optimum for a particular application. A rotary part 1001 and a detent mechanism 1002 allow the different lenses 1010 to align with light emitted from the laser 704 in an accurate manner. To increase accuracy and eliminate calibration, the lenses 1010 are shown as a single integral member of the rotary part 1001; however, the lenses can be individual lenses mounted within the rotary part 1001. The rotary part 1001 is a disk shaped member that spaces the lenses 1010 in a circular arrangement. A circular head screw 1052 positioned through a center aperture 1050 of the rotary part 1001 attaches the rotary part 1001 to the laser level 100 such that the rotary part 1001 rotates about the screw 1052.

As shown, the detent mechanism 1002 includes a biasing member 1004 that urges a ball bearing 1006 into a substantially 90-degree “V” shape 1008 in an outside diameter of the rotary part 1000. This caming motion of the detent mechanism 1002 centers the “V” shape 1008 of the rotary part 1001 relative to the ball bearing 1006 and holds the lenses 1010 in accurate angular alignment to the laser 704 and/or vials 108 and to a lesser extent the base 104. The center aperture 1050 of the rotary part 1001 is preferably a polygonal shape having an equivalent number of sides as the number of positions of the rotary part 1001. Thus, the center aperture 1050 is hexagonal since the rotary part 1001 that is shown includes six positions. An outside diameter of the screw 1052 biases into contact with two contiguous sides of the hexagonal center aperture 1050 when the detent mechanism 1002 selectively positions the rotary part 1001. This centers the screw 1052 within the angle formed by the contiguous sides in order to correctly position the screw 1052 against the center aperture 1050 for each position of the rotary part 1001. Thus, the ball bearing 1006 inexpensively provides extremely tight tolerances that contribute to the accuracy of the laser level 100, and the hexagonal center aperture 1050 further provides centering forces on the rotary part 1001 in order to hold the rotary part 1001 stable and consistent.

The rotary part 1001 includes six positions with five discrete lenses 1010. The sixth position is an aperture 1012 that allows the laser 704 to project through as a “dot” rather than being converted into a line. In this manner, the laser level 100 can be used as a laser pointer for example. The five lenses 1010 can be selected for asymmetrical near wall dispersion, symmetrical vertical dispersion, symmetrical horizontal dispersion, cross-shaped symmetrical dispersion, and 45-degree cross-shaped symmetrical dispersion. Depending on the orientation of the laser level 100, the “horizontal” line could be “vertical” and vice versa. While five lenses 1010 are shown in the example, the laser level 100 can have a single lens or any number of lenses depending on what functions are desired. Additionally, the dispersion patterns provided by lenses 1010 are merely examples of some of the possible different dispersions or shapes that lenses 1010 within the rotary part 1001 can provide. Examples of other possible lens patterns include a square dispersion or a circular dispersion for uses such as providing templates when making a window cutout. The size of these geometric objects displayed on a surface can be varied by adjusting the distance of the laser level from the surface.

Referring back to FIG. 2, a portion of the outside diameter of the rotary part 1001 is accessible through an aperture within the housing 102 so that one can rotate the rotary part 1001 and select the optimum lens for a particular application. As shown, a number indicator on the outside diameter of the rotary part 1001 may provide a visual indication of which lens is selected.

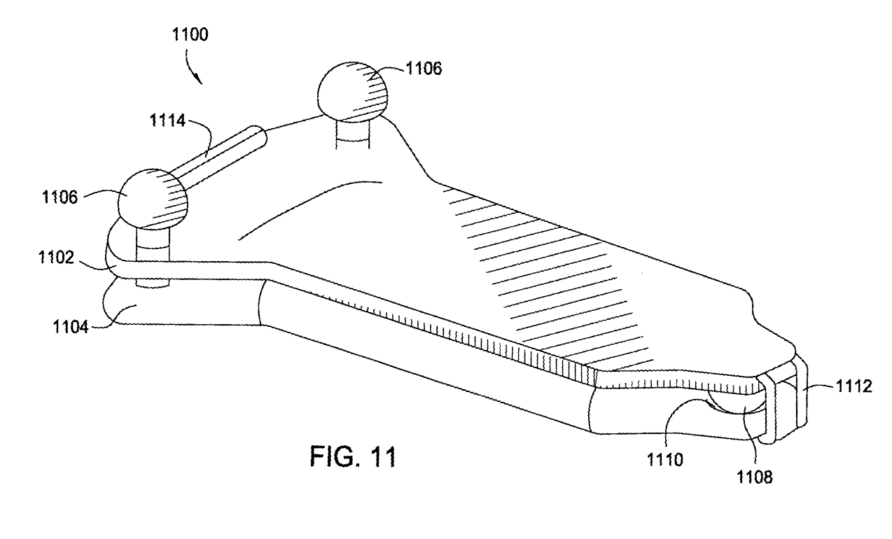

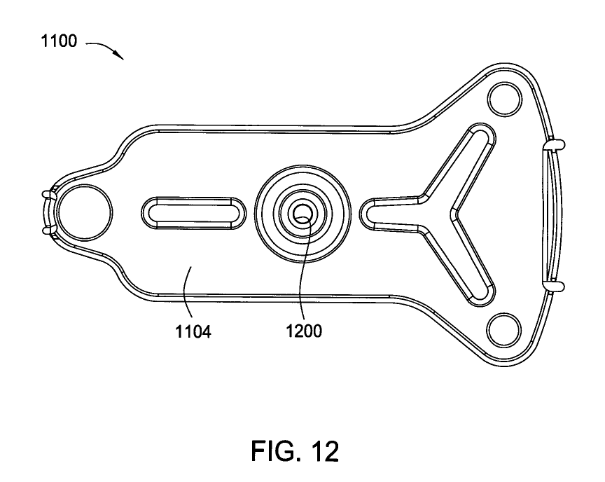

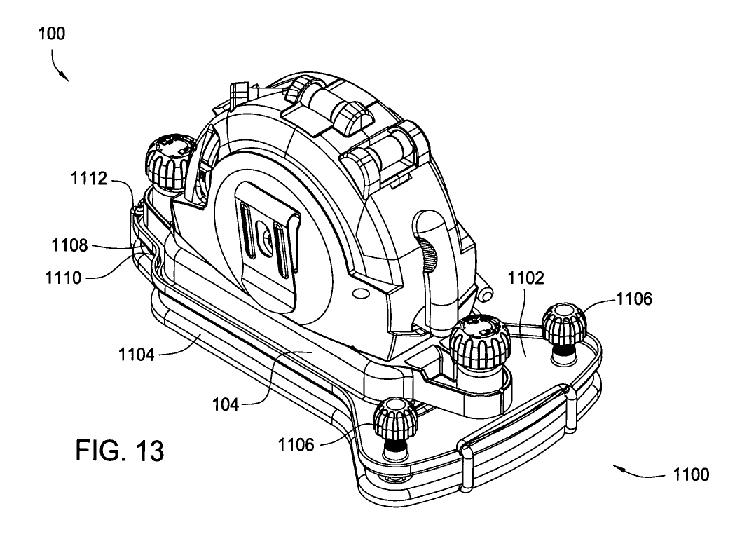

FIG. 11 and FIG. 12 show an optional auxiliary base 1100 for use in conjunction with the laser level 100 as shown in FIG. 13. Referring to FIG. 11, the auxiliary base 1100 includes upper and lower parallel plates 1102, 1104 having a shape that accommodates the base 104 of the laser level 100. The auxiliary base 1100 uses two screws 1106 that extend through the upper plate 1102 and rest on the lower plate 1104 and a ball 1108 in a socket 1110 positioned between the plates 1102, 1104 for intuitive leveling of the laser level 100 and a compact design. The laser level 100 attaches to the auxiliary base 1100 preferably by the magnet (not shown) since at least the upper plate 1102 that the laser level 100 mounts to is preferably ferrous; however, the laser level 100 can attach by using the suction assembly (not shown). A forward elastomer 1112 positioned at the front of the auxiliary base 1100 and a rear elastomer 1114 positioned at the back of the auxiliary base 1100 attach to both of the parallel plates 1102, 1104. The elastomers 1112, 1114 keep both the parallel plates 1102, 1104 of the auxiliary base 1100 pressed firmly together irrespective of how the screws 1106 are adjusted. Therefore, the elastomers 1112, 1114 allow the laser level 100 with the auxiliary base 1100 to be used when mounted on its side as well as when significantly horizontal. As shown in FIG. 12, a female thread 1200 located on the bottom side of the lower plate 1104 allows mounting of the auxiliary base 1100 to a tripod (not shown). Two or more threads can be provided on the bottom of the lower plate 1104 so that the auxiliary base 1100 will attach to tripods with different screw standards. Alternatively, adapters can be used with the single thread 1200 so that the auxiliary base 1100 will work in conjunction with a plurality of different tripod screw standards.

The auxiliary base 1100 allows the laser level 100 to be attached to it and accurately leveled in two perpendicular planes. Since the screws 1106 are located at the back of the auxiliary base 1100 and the ball in socket 1108, 1110 is located at the front of the auxiliary base 1100, the upper plate 1102 pivots on the ball 1108 when both screws 1106 rotate to level the laser level 100 from front to back. Additionally, the ball 1108 allows the upper plate 1102 to pivot from side to side relative to the lower plate 1104. The screws 1106 are spaced apart in a plane perpendicular to the plane defined between the front and back of the auxiliary base 1100 such that rotation of only one screw or rotation of each screw 1 106 in opposite directions levels the laser level 100 from side to side. Leveling the laser level 100 in two perpendicular planes allows the laser level 100 to project accurate horizontal or vertical lines on two or more non-parallel walls/surfaces simultaneously.

Embodiments of the laser level shown and described herein utilize the magnets, the suction assembly, and the anchor assembly all in one complete laser level. However, other embodiments of the laser level may utilize one of these types of attachment mechanisms or any combination of these mechanisms.

Use of a laser level 100 according to the present invention includes attaching the laser level 100 to a surface by a magnet 600, a suction assembly 500 and/or an anchor assembly 114. With the magnet 600, attaching the laser level 100 involves contacting a base 104 of the laser level 100 directly to any ferrous material. Operating the suction assembly 500 for attaching the laser level 100 includes rotating a lever 112 approximately 180 degrees to raise a portion of a pad 110 thereby creating a suction that attaches the laser level 100 to the surface. Operating the anchor assembly 114 includes unlocking the anchor assembly 114 and extending a retractable sharpened projection 300 into the surface. Rotating a rotary part 1001 of a rotary lens assembly 1000 selects from multiple lenses 1010 the one appropriate lens for the desired task. Attaching the laser level 100 to an auxiliary base 1100 provides the ability to attach the laser level 100 to a tripod. Further, adjusting two screws 1106 on the auxiliary base 1100 provides leveling of the laser level 100 in two perpendicular planes. Opening a window on the laser level 100 turns on a laser 704. Projecting a laser beam of the laser 704 on the surface or another surface displays a reference line used for various tasks.

While the foregoing is directed to embodiments of the present invention, other and further embodiments of the invention may be devised without departing from the basic scope thereof, and the scope thereof is determined by the claims that follow.

1. A laser level assembly, comprising:
a base having a laser coupled thereto;
at least one attachment means for attaching the laser level to a surface, the attachment means selected from at least one member of the group consisting of a suction assembly, an anchoring assembly, a magnet, and an adhesive;
an adjustment assembly, wherein the adjustment assembly provides a micro adjustment of at least a portion of the laser level relative to the surface;
a lens assembly, wherein the lens assembly selectively aligns and positions one of at least two lenses with respect to the laser; and
an auxiliary base attachable to the base to provide leveling adjustments.

2. A laser level assembly, comprising:
a base;
a laser; and
a suction assembly to provide a suction between the suction assembly and a surface, the suction for attaching the laser level assembly to the surface.

3. The laser level assembly of claim 2, wherein the suction assembly comprises:
a pad;
a yoke operatively connected to the pad; and
a lever extending to the yoke and shaped to raise the yoke when moved from a first position to a second position.

4. The laser level assembly of claim 3, wherein the pad comprises a lip surrounding a periphery of the pad for contact with the surface.

5. The laser level assembly of claim 3, wherein an outer periphery wall of the base and at least one inner wall of the base located a distance from the outer periphery wall press against the pad to provide a seal between the surface and the pad.

6. The laser level assembly of claim 3, further comprising a magnet operatively connected to the yoke.

7. The laser level assembly of claim 2, further comprising an adapter unit for use with an adhesive to attach the laser level to the surface.

8. The laser level assembly of claim 2, further comprising a 45 degree vial.

9. The laser level assembly of claim 2, further comprising a belt clip.

10. A laser level assembly, comprising:
a base;
a structural member pivotally secured to the base;
a laser secured to the structural member; and
an adjustment assembly, wherein the adjustment assembly provides a movement of the structural member relative to the base that is less than a movement applied to a handle of the adjustment assembly.

11. The laser level assembly of claim 10, wherein the adjustment assembly comprises a Scotch Yoke.

12. The laser level assembly of claim 10, further comprising a 45 degree vial.

13. The laser level assembly of claim 10, further comprising a belt clip.

14. A laser level assembly, comprising:
a base;
a laser; and
a lens assembly, wherein the lens assembly selectively aligns and positions one of at least two lenses with respect to the laser.

15. The laser level assembly of claim 14, wherein the lens assembly comprises at least three lenses.

16. The laser level assembly of claim 14, wherein the lens assembly is rotatable.

17. The laser level assembly of claim 16, wherein the lens assembly comprises a rotary part that spaces the at least two lenses on a plane in a circular arrangement.

18. The laser level assembly of claim 16, wherein the lens assembly comprises:
a rotary part that secures the at least two lenses on a plane in a circular arrangement; and
a detent mechanism, wherein a ball of the detent mechanism urges into a profile on an outside circumference of the rotary part.

19. The laser level assembly of claim 18, wherein the rotary part comprises a polygonal shaped center aperture with a member at least partially therein to attach the rotary part to the laser level assembly.

20. The laser level assembly of claim 14, further comprising a 45 degree vial.

21. The laser level assembly of claim 14, further comprising a belt clip.

22. A laser level assembly, comprising:
a base;
a laser; and
a lens assembly comprising multiple lenses wherein a first lens provides a first symmetrical linear dispersion and a second lens provides an asymmetrical linear dispersion.

23. The laser level assembly of claim 22, wherein a third lens provides a cross-shaped symmetrical dispersion.

24. The laser level assembly of claim 22, wherein a third lens provides a second symmetrical linear dispersion that is oriented ninety degrees relative to the first symmetrical linear dispersion.

25. The laser level assembly of claim 22, wherein a third lens provides a circular dispersion.

26. A laser level assembly, comprising:
a base;
a laser; and
at least one anchoring assembly for attaching the laser level to a surface, comprising:
at least one retractable sharpened projection; and
a locking mechanism for selectively securing the at least one retractable sharpened projection in a retracted position.

27. The laser level assembly of claim 26, wherein the locking mechanism includes at least one rib within a base of the laser level assembly that aligns in an unlocked position and misaligns in a locked position with at least one slot in a circumference of the at least one retractable sharpened projection.

28. The laser level assembly of claim 26, further comprising an adapter member for use with an adhesive to attach the laser level to the surface.

29. The laser level assembly of claim 28, wherein the adapter member includes a compartment for storing the adhesive.

30. The laser level assembly of claim 26, further comprising a 45 degree vial.

31. The laser level assembly of claim 26, further comprising a belt clip.

32. A laser level assembly, comprising:
a base having a laser coupled thereto; and
a member removable from the base, the member having a flat surface on one side for attaching an adhesive and a compartment on an opposite side for storing the adhesive, wherein the adhesive attaches the laser level to a surface.

33. A laser level assembly, comprising:
a laser lever;
an auxiliary base comprising:
an upper plate;
a lower plate;
at least one elastomer connected to each plate; and
two screws at a first end of the auxiliary base that extend through the upper plate and contact the lower plate to provide leveling adjustments.

34. The laser level assembly of claim 33, further comprising a ball positioned within a socket defined by an area between the upper and lower plates at a second end of the auxiliary base.

35. A method for projecting a reference line on an object, comprising:
contacting a suction assembly of a laser level to a surface;
rotating a lever of the suction assembly to raise a portion of a pad thereby creating a suction between the pad and the surface; and
projecting a laser on the object to display the reference line.

36. The method of claim 35, further comprising:
rotating a rotary part to select a lens.

37. The method of claim 35, further comprising:
rotating an adjustment handle to provide micro adjustments of the laser level relative to the surface.

38. A method for projecting a reference line on an object, comprising:
attaching a laser level to a surface;
rotating an adjustment handle to provide micro adjustments of the laser level relative to the surface; and
projecting a laser on the object to display the reference line.
